(19) United States
(12) Patent Application Publication
(10) Pub. No.: US 2025/0161925 A1
(43) Pub. Date: May 22, 2025

(54) USE OF SPECIFIC CATALYSTS FOR THE PREPARATION OF POLYURETHANE COATINGS

(71) Applicant: Covestro Deutschland AG, Leverkusen (DE)

(72) Inventors: Frank Richter, Leverkusen (DE); Sven Siegemund, Burscheid (DE)

(21) Appl. No.: 18/839,470

(22) PCT Filed: Feb. 23, 2023
(86) PCT No.: PCT/EP2023/054567

§ 371 Date: Aug. 19, 2024

(30) Foreign Application Priority Data
Feb. 28, 2022 (EP) 22159155.5

(51) Int. Cl. B01J 31/22; C08G 71/04

(52) U.S. Cl. CPC B01J 31/2213; C08G 71/04; B01J 2523/43

(57) ABSTRACT

The present invention relates to a compound for use as catalyst in the production of polyisocyanate polyaddition products, to the production thereof and to the use thereof as catalyst, preferably as thermolatent catalyst, for production of polyisocyanate polyaddition products. The invention further relates to a formulation and to a process for producing polyisocyanate polyaddition products, each using the compound of the invention, and to a polyisocyanate polyaddition product obtained or obtainable by said process. The invention finally relates to a coating composition for coating a substrate, comprising or consisting of the polyisocyanate polyaddition product of the invention.

The present invention relates to a compound for use as catalyst in the production of polyisocyanate polyaddition products, to the production thereof and to the use thereof as catalyst, preferably as thermolatent catalyst, for production of polyisocyanate polyaddition products. The invention further relates to a formulation and to a process for producing polyisocyanate polyaddition products, each using the compound of the invention, and to a polyisocyanate polyaddition product obtained or obtainable by said process. The invention finally relates to a coating composition for coating a substrate, comprising or consisting of the polyisocyanate polyaddition product of the invention.

### PRIOR ART

Polyurethane coatings have been known for a long time and are used in many sectors. They are generally produced from a polyisocyanate component and a hydroxyl component by mixing immediately prior to application (2-component (2K) technology). Lightfast coatings generally employ polyisocyanate components based on aliphatic polyisocyanates, which react with the hydroxyl component considerably more slowly compared to products having aromatically bonded isocyanate groups. The reaction must therefore be catalyzed in most cases. In addition, the mixture is heated if possible for further acceleration of the reaction. Organic tin compounds, in particular dibutyltin dilaurate (DBTL), have been found to be useful here as catalysts. These have the general disadvantage of an unfavorable ecological profile, which has inter alia already led to the substance class of organotin compounds being completely banned from marine paints, to which they had been added as a biocide.

A general disadvantage of 2K technology is that the reaction of the NCO groups with the OH groups already proceeds slowly at room temperature, which means there is only a narrow time window, called the pot life, available for processing the ready-formulated mixture of such a 2K system, which is shortened further by the presence of the catalyst.

There has therefore been no lack of attempts to develop catalysts which barely accelerate the crosslinking reaction on production of the 2K mixture, but distinctly accelerate it after application, known as latent catalysts.

A particularly promising technology is thermolatent catalysis using inorganic tin compounds, as described for example in WO 2011/051247 A1. One disadvantage of the thermolatent catalysis systems specified in the prior art is that the catalyst requirement is quite high and that the stability of the polyisocyanate curing agents is sometimes unsatisfactory, for example with regard to yellowing and/or rising viscosity, usually accompanied by a drop in isocyanate content (NCO drop).

This effect occurs particularly in the case of polyisocyanates containing iminooxadiazinedione groups, obtainable for example according to the teaching of EP 798 299 B1, EP 3 337 836 A1 or EP 3 107 948 A1, and so it has not been possible in practice to date to modify this substance class with thermolatent catalysts.

### OBJECT OF THE INVENTION

It was therefore an object of the present invention to provide a compound for use as catalyst in the production of polyisocyanate polyaddition products. In particular, the compound, with an otherwise unchanged or even improved profile of properties, was to have a long pot life and sufficient hardness of the products produced and relatively low catalyst loading, or was to enable higher reactivity with the same catalyst loading. Moreover, the compound was to enable a tendency to yellowing and/or a rise in viscosity/NCO drop of the products at least at the level of the existing prior art systems. The pot life is the time within which the viscosity of the ready-formulated paint formulation has increased to an unacceptable degree. It is determined indirectly, for example, via the doubling of the flow time of the ready-formulated paint formulation in a DIN 4 cup. These improved catalyst systems were likewise to be very substantially free of toxic ingredients, for example cadmium, mercury, lead and/or organotin compounds, and were to be producible proceeding from inexpensive, industrially readily available reactants. Organotin compounds are understood by definition to mean species having at least one Sn—C bond in the molecule.

### Achievement of the Object

These objects were surprisingly achieved by a compound having the general formula (I) or (II) for use as catalyst in the production of polyisocyanate polyaddition products:

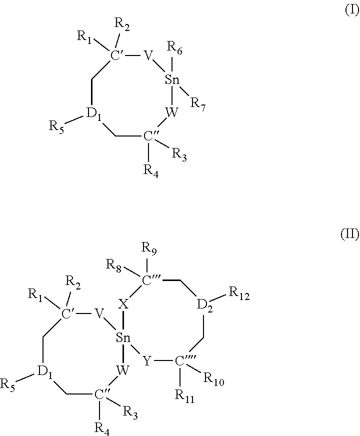

where
   R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
   R₅ and R₁₂ are independently aliphatic, (cyclo)aliphatic or aromatic radicals that are optionally substituted and/or have heteroatoms;
   R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
   V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
   D₁ and D₂ are independently oxygen, sulfur or nitrogen;
characterized in that in formula (I) at least one of the R₁, R₂, R₃ or R₄ radicals is hydrogen and at least one of these radicals is not hydrogen, where the carbon atoms C′ and C″ do not bear the same radicals, and in formula (II) at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

In addition, the invention relates to a process for producing the inventive compound having the general formula (I) by reacting either
a tin-containing compound of the R₆R₇SnZ₂ type with
a compound of the general formula (III):

HV—C′(R₁;R₂)—CH₂-D₁(R₅)—CH₂—C″(R₃;R₄)—WH (III)

or
a tin-containing compound of the SnZ₄ type with
a compound of the general formula (III); and

HV—C′(R₁;R₂)—CH₂-D₁(R₅)—CH₂—C″(R₃;R₄)—WH (III)
and then with compounds of the general formulae (IV) and (V):

R₆-A (IV)

R₇-A (V)

where
R₁, R₂, R₃, R₄ are independently hydrogen or are aliphatic, (cyclo)aliphatic or aromatic radicals that are optionally substituted and/or have heteroatoms;
R₅ is independently aliphatic, (cyclo)aliphatic or aromatic radicals that are optionally substituted and/or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
V and W are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ is oxygen, sulfur or nitrogen;
A is leaving groups, preferably —OH, —SH, N(R₂₂)H— or halogens, where R₂₂ is aliphatic, (cyclo)aliphatic or aromatic radicals that are optionally substituted and/or have heteroatoms;
Z is halogens, alkoxides or mixtures thereof;
   characterized in that at least one of the R₁, R₂, R₃ or R₄ radicals is hydrogen and at least one of these radicals is not hydrogen, where the carbon atoms C′ and C″ do not bear the same radicals.

The invention also relates to processes for producing the inventive compound having the general formula (II) by reaction of elemental tin or a tin-containing compound with
a compound having the general formula (III); and

HV—C′(R₁;R₂)—CH₂-D₁(R₅)—CH₂—C″(R₃;R₄)—WH (III)
a compound having the general formula (IV);

HX—C″′(R₈;R₉)—CH₂-D₂(R₁₂)—CH₂—C″″(R₁₀;R₁₁)—YH (VI);

where
R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
R₅ and R₁₂ are independently aliphatic, (cyclo)aliphatic or aromatic radicals that are optionally substituted and/or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ and D₂ are independently oxygen, sulfur or nitrogen;
   characterized in that at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

The compound further relates to the use of an inventive compound as catalyst, preferably as thermolatent catalyst for production of polyisocyanate polyaddition products, especially polyurethanes, preferably polyurethane foams, polyurethane coatings, polyurethane paints or polyurethane adhesives.

Furthermore, the invention relates to a formulation for production of polyisocyanate polyaddition products, comprising or consisting of the following components:
a) at least one aliphatic, (cyclo)aliphatic or aromatic polyisocyanate that is optionally substituted and/or has heteroatoms;
b) at least one compound of the invention as catalyst;
c) optionally further catalysts other than b);
d) optionally auxiliaries and/or additives,
   where the ratio of the weight of tin from component b) and the weight of component a) is preferably not more than 1000 ppm when component a) is an aliphatic and/or (cyclo)aliphatic polyisocyanate, and is not more than 50 ppm when component a) is an aromatic polyisocyanate.

The invention also relates to a process for producing polyisocyanate polyaddition products by reaction of a composition:
comprising or consisting of at least one formulation as claimed in claim 16 and at least one NCO-reactive compound, where the reaction is preferably effected at an isocyanate index of 80 to 150,
   or
comprising or consisting of the following components:
A) at least one aliphatic, (cyclo)aliphatic or aromatic polyisocyanate that is optionally substituted and/or has heteroatoms;
B) at least one NCO-reactive compound;
C) at least one compound of the invention as catalyst;
D) optionally further catalysts other than C);
E) optionally auxiliaries and/or additives,
where the ratio of the weight of tin from component C) and the weight of component A) is preferably not more than 1000 ppm when component A) is an aliphatic and/or (cyclo)aliphatic polyisocyanate, and is not more than 50 ppm when component A) is an aromatic polyisocyanate.

The invention additionally relates to a polyisocyanate polyaddition product obtained or obtainable by the aforementioned process of the invention.

The invention finally relates to a coating composition for coating a substrate, comprising or consisting of at least one polyisocyanate polyaddition product of the invention, where the substrate is preferably a plastics part, a metal part or a shaped body made of wood.

### The Compound of the Invention

The invention provides a compound of the general formula (I) or (II) for use as catalyst in the production of polyisocyanate polyaddition products:

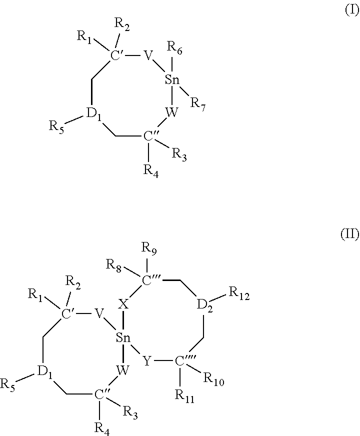

where
R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
R₅ and R₁₂ are independently aliphatic, (cyclo)aliphatic or aromatic radicals that are optionally substituted and/or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ and D₂ are independently oxygen, sulfur or nitrogen;
characterized in that in formula (I) at least one of the R₁, R₂, R₃ or R₄ radicals is hydrogen and at least one of these radicals is not hydrogen, where the carbon atoms C′ and C″ do not bear the same radicals, and in formula (II) at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

Preferably, the at least one R₁, R₂, R₃ or R₄ radical in formula (I) that is not hydrogen and the at least one R₁, R₂, R₃, R₄, R₈, R₉, R₁₀ or R₁₁ radical in formula (II) that is not hydrogen is aliphatic and is preferably a methyl, ethyl, propyl, butyl, hexyl, octyl or perfluoroalkyl radical.

It is also preferable that R₅ and/or R₁₂ is a methyl, ethyl, propyl, butyl, pentyl, hexyl or octyl radical, further preferably a methyl, butyl or ethyl radical.

V, W, X and Y are preferably oxygen and/or D₁ and D₂ are nitrogen.

Moreover, it is preferable that R₆ and R₇ are identical.

In a preferred embodiment, the compound of formula (II) is characterized in that the at least one R₁, R₂, R₃, R₄, R₈, R₉, R₁₀ or R₁₁ radical in formula (II) that is not hydrogen is a methyl, ethyl, propyl, butyl, hexyl, octyl or perfluoroalkyl radical, preferably a methyl radical, and in that R₅ and R₁₂ are independently aliphatic, (cyclo)aliphatic or aromatic radicals that are optionally substituted and/or have heteroatoms, are preferably the same and are a methyl, ethyl, propyl, butyl, pentyl, hexyl or octyl radical, and are more preferably the same and are a methyl, butyl or ethyl radical, and in that V, W, X and Y are oxygen and D₁ and D₂ are nitrogen.

In a preferred embodiment, the compound of formula (II) is characterized in that
R₁ is a methyl, ethyl, propyl, butyl, hexyl, octyl or perfluoroalkyl radical, preferably a methyl radical, and the R₂, R₃, R₄, R₈, R₉, R₁₀ and R₁₁ radicals are hydrogen,
or
R₁ and R₂ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₃, R₄, R₈, R₉, R₁₀ and R₁₁ radicals are hydrogen,
or
R₁ and R₁₀ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₂, R₃, R₄, R₈, R₉ and R₁₁ radicals are hydrogen,
or
R₁, R₂ and R₁₀ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₃, R₄, R₈, R₉ and R₁₁ radicals are hydrogen,
or
R₁, R₂, R₁₀ and R₁₁ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₃, R₄, R₈ and R₉ radicals are hydrogen,
and
in that R₅ and R₁₂ are independently aliphatic, (cyclo)aliphatic or aromatic radicals that are optionally substituted and/or have heteroatoms, are preferably the same and are a methyl, ethyl, propyl, butyl, pentyl, hexyl or octyl radical, and are more preferably the same and are a methyl, butyl or ethyl radical,
and
in that V, W, X and Y are oxygen and D₁ and D₂ are nitrogen.

In a preferred embodiment, the compound of the invention is selected from the group comprising or consisting of
2,2-dichloro-4,6-dimethyl-1,3,6,2-dioxazastannocane, 2,2-dibromo-4,6-dimethyl-1,3,6,2-dioxazastannocane, 2,2-dimethoxy-4,6-dimethyl-1,3,6,2-dioxazastannocane, 4,6-dimethyl-1,3,6,2-dioxazastannocane-2,2-diyl dibenzoate, 6-ethyl-4-methyl-1,3,6,2-dioxazastannocane-2,2-diyl dibenzoate, 6-butyl-4-methyl-1,3,6,2-dioxazastannocane-2,2-diyl dibenzoate, 2,4,12-trimethyl-1,7,9,15-tetraoxa-4,12-diaza-8-stannaspiro[7.7]pentadecane, 2,2,4,12-tetramethyl-1,7,9,15-tetraoxa-4,12-diaza-8-stannaspiro[7.7]pentadecane, 2,4,10,12-tetramethyl-1,7,9,15-tetraoxa-4,12-diaza-8-stannaspiro[7.7]pentadecane, 2,2,4,10,12-pentamethyl-1,7,9,15-tetraoxa-4,12-diaza-8-stannaspiro[7.7]pentadecane, 2,2,4,10,10,12-hexamethyl-1,7,9,15-tetraoxa-4,12-diaza-8-stannaspiro[7.7]pentadecane, 2,2,4,6,10,10,12-heptamethyl-1,7,9,15-tetraoxa-4,12-diaza-8-stannaspiro[7.7]pentadecane, 2,2,4,6,6,10,10,12-octamethyl-1,7,9,15-tetraoxa-4,12-diaza-8-stannaspiro[7.7]pentadecane, 2,2,4,6,6,10,10,12,14-nonamethyl-1,7,9,15-tetraoxa-4,12-diaza-8-stannaspiro[7.7]pentadecane, 4,12-diethyl-2-methyl-1,7,9,15-tetraoxa-4,12-diaza-8-stannaspiro[7.7]pentadecane, 4,12-diethyl-2,2-dimethyl-1,7,9,15-tetraoxa-4,12-diaza-8-stannaspiro[7.7]pentadecane, 4,12-diethyl-2,10-dimethyl-1,7,9,15-tetraoxa-4,12-diaza-8-stannaspiro[7.7]pentadecane, 4,12-diethyl-2,2,10-trimethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-diethyl-2,2,6,10,10-pentamethyl-1,7,9,15-tetraoxa-4,12-diaza-8-stannaspiro[7.7]pentadecane, 4,12-diethyl-2,2,6,6,10,10-hexamethyl-1,7,9,15-tetraoxa-4,12-diaza-8-stannaspiro[7.7]pentadecane, 4,12-diethyl-2,2,6,6,10,10,14-heptamethyl-1,7,9,15-tetraoxa-4,12-diaza-8-stannaspiro[7.7]pentadecane, 4,12-dibutyl-2-methyl-1,7,9,15-tetraoxa-4,12-diaza-8-stannaspiro[7.7]pentadecane, 4,12-dibutyl-2,2-dimethyl-1,7,9,15-tetraoxa-4,12-diaza-8-stannaspiro[7.7]pentadecane, 4,12-dibutyl-2,10-dimethyl-1,7,9,15-tetraoxa-4,12-diaza-8-stannaspiro[7.7]pentadecane, 4,12-dibutyl-2,2,10-trimethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dibutyl-2,2,6,10,10-pentamethyl-1,7,9,15-tetraoxa-4,12-diaza-8-stannaspiro[7.7]pentadecane, 4,12-dibutyl-2,2,6,6,10,10-hexamethyl-1,7,9,15-tetraoxa-4,12-diaza-8-stannaspiro[7.7]pentadecane, 4,12-dibutyl-2,2,6,6,10,10,14-heptamethyl-1,7,9,15-tetraoxa-4,12-diaza-8-stannaspiro[7.7]pentadecane, 4,12-dibutyl-2-(trifluoromethyl)-1,7,9,15-tetraoxa-4,12-diaza-8-stannaspiro[7.7]pentadecane, 4,12-dibutyl-2,10-bis(trifluoromethyl)-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof,
preferably 2,4,12-trimethyl-1,7,9,15-tetraoxa-4,12-diaza-8-stannaspiro[7.7]pentadecane, 2,2,4,12-tetramethyl-1,7,9,15-tetraoxa-4,12-diaza-8-stannaspiro[7.7]pentadecane, 2,4,10,12-tetramethyl-1,7,9,15-tetraoxa-4,12-diaza-8-stannaspiro[7.7]pentadecane, 2,2,4,10,12-pentamethyl-1,7,9,15-tetraoxa-4,12-diaza-8-stannaspiro[7.7]pentadecane, 2,2,4,10,10,12-hexamethyl-1,7,9,15-tetraoxa-4,12-diaza-8-stannaspiro[7.7]pentadecane, 2,2,4,6,10,10,12-heptamethyl-1,7,9,15-tetraoxa-4,12-diaza-8-stannaspiro[7.7]pentadecane, 2,2,4,6,6,10,10,12-octamethyl-1,7,9,15-tetraoxa-4,12-diaza-8-stannaspiro[7.7]pentadecane, 2,2,4,6,6,10,10,12,14-nonamethyl-1,7,9,15-tetraoxa-4,12-diaza-8-stannaspiro[7.7]pentadecane, 4,12-diethyl-2-methyl-1,7,9,15-tetraoxa-4,12-diaza-8-stannaspiro[7.7]pentadecane, 4,12-diethyl-2,2-dimethyl-1,7,9,15-tetraoxa-4,12-diaza-8-stannaspiro[7.7]pentadecane, 4,12-diethyl-2,10-dimethyl-1,7,9,15-tetraoxa-4,12-diaza-8-stannaspiro[7.7]pentadecane, 4,12-diethyl-2,2,10-trimethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-diethyl-2,2,6,10,10-pentamethyl-1,7,9,15-tetraoxa-4,12-diaza-8-stannaspiro[7.7]pentadecane, 4,12-diethyl-2,2,6,6,10,10-hexamethyl-1,7,9,15-tetraoxa-4,12-diaza-8-stannaspiro[7.7]pentadecane, 4,12-diethyl-2,2,6,6,10,10,14-heptamethyl-1,7,9,15-tetraoxa-4,12-diaza-8-stannaspiro[7.7]pentadecane, 4,12-dibutyl-2-methyl-1,7,9,15-tetraoxa-4,12-diaza-8-stannaspiro[7.7]pentadecane, 4,12-dibutyl-2,2-dimethyl-1,7,9,15-tetraoxa-4,12-diaza-8-stannaspiro[7.7]pentadecane, 4,12-dibutyl-2,10-dimethyl-1,7,9,15-tetraoxa-4,12-diaza-8-stannaspiro[7.7]pentadecane, 4,12-dibutyl-2,2,10-trimethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dibutyl-2,2,6,10,10-pentamethyl-1,7,9,15-tetraoxa-4,12-diaza-8-stannaspiro[7.7]pentadecane, 4,12-dibutyl-2,2,6,6,10,10-hexamethyl-1,7,9,15-tetraoxa-4,12-diaza-8-stannaspiro[7.7]pentadecane, 4,12-dibutyl-2,2,6,6,10,10,14-heptamethyl-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof,
more preferably 2,2,4,10,10,12-hexamethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof,
most preferably 2,2,4,10,10,12-hexamethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane or mixtures thereof.

The compound of the invention may especially be used as catalyst, more preferably as thermolatent catalyst for production of polyisocyanate polyaddition products, especially polyurethane, preferably polyurethane foams, polyurethane coatings, polyurethane paints or polyurethane adhesives. As thermolatent catalyst, the compound of the invention evolved its activity preferably by virtue of an increase in temperature, for example to 60 to 100° C.

### Process for Producing the Compounds of the Invention

### Compounds Having the General Formula (I):

The inventive compound having the general formula (1) can be prepared by reaction of either
a tin-containing compound of the R₆R₇SnZ₂ type with
a compound of the general formula (III):

HV—C′(R₁;R₂)—CH₂-D₁(R₅)—CH₂—C″(R₃;R₄)—WH (III)

or
a tin-containing compound of the SnZ₄ type with
a compound of the general formula (III); and

HV—C′(R₁;R₂)—CH₂-D₁(R₅)—CH₂—C″(R₃;R₄)—WH (III)
and then with compounds of the general formulae (IV) and (V):

R₆-A (IV)

R₇-A (V)

where
R₁, R₂, R₃, R₄ are independently hydrogen or are aliphatic, (cyclo)aliphatic or aromatic radicals that are optionally substituted and/or have heteroatoms;
R₅ is independently aliphatic, (cyclo)aliphatic or aromatic radicals that are optionally substituted and/or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
V and W are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ is oxygen, sulfur or nitrogen;
A is leaving groups, preferably —OH, —SH, N(R₂₂)H— or halogens, where R₂₂ is aliphatic, (cyclo)aliphatic or aromatic radicals that are optionally substituted and/or have heteroatoms;
Z is halogens, alkoxides or mixtures thereof;
   characterized in that at least one of the R₁, R₂, R₃ or R₄ radicals is hydrogen and at least one of these radicals is not hydrogen, where the carbon atoms C′ and C″ do not bear the same radicals.

It is preferable here that
the compound of the general formula (III) comprises or consists of 2,2′-(methylazanediyl)bis(ethan-1-ol), 2,2′-(ethylazanediyl)bis(ethan-1-ol), 2,2′-(butylazanediyl)bis(ethan-1-ol), 1-((2-hydroxyethyl)(methyl)amino)propan-2-ol, 1-(ethyl(2-hydroxyethyl)amino)propan-2-ol, 1-(butyl(2-hydroxyethyl)amino)propan-2-ol, 1,1′-(methylazanediyl)bis(propan-2-ol), 1,1′-(ethylazanediyl)bis(propan-2-ol), 1,1′-(butylazanediyl)bis(propan-2-ol), 1-((2-hydroxyethyl)(methyl)amino)-2-methylpropan-2-ol, 1-(ethyl(2-hydroxyethyl)amino)-2-methylpropan-2-ol, 1-(butyl(2-hydroxyethyl)amino)-2-methylpropan-2-ol, 1-(ethyl(2-hydroxypropyl)amino)-2-methylpropan-2-ol, 1-(butyl(2-hydroxypropyl)amino)-2-methylpropan-2-ol or mixtures thereof, preferably 1-((2-hydroxyethyl)(methyl)amino)-2-methylpropan-2-ol, 1-(ethyl(2-hydroxyethyl)amino)-2-methylpropan-2-ol, 1-(butyl(2-hydroxyethyl)-amino)-2-methylpropan-2-ol or mixtures thereof; and/or
   the compound of the general formula (IV) and/or of the general formula (V) comprises or consists of halogen, halides, alkoxides, carboxylates, peroxides, disulfides or mixtures thereof.

The tin-containing compound of the SnZ₄ type is preferably selected from the group comprising or consisting of tin tetrachloride, tin tetrabromide, tin tetra-tert-alkoxide, especially tin tetra-tert-butoxide, or mixtures thereof. It is also preferable that the molar ratio of tin-containing compound to the sum total of the compounds having the general formulae (III), (IV) and (V) is from 1:1 to 1:4, preferably from 1:1 to 1:2.1.

Preferably, Z in the tin-containing compound of the R₆R₇SnZ₂ type is halogens, for example chlorine (R₆R₇SnCl₂).

### Compounds Having the General Formula (II):

The compound of the invention having the general formula (II) can be produced by reaction of elemental tin or a tin-containing compound with
a compound having the general formula (III); and

HV—C′(R₁;R₂)—CH₂-D₁(R₅)—CH₂—C″(R₃;R₄)—WH (III)
a compound having the general formula (IV);

HX—C″′(R₈;R₉)—CH₂-D₂(R₁₂)—CH₂—C″″(R₁₀;R₁₁)—YH (VI);

where
R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
R₅₅ and R₁₂ are independently aliphatic, (cyclo)aliphatic or aromatic radicals that are optionally substituted and/or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ and D₂ are independently oxygen, sulfur or nitrogen;
   characterized in that at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

It is preferable that the compound of the general formula (III) and/or the compound of the general formula (VI) comprises or consists of 2,2′-(methylazanediyl)bis(ethan-1-ol), 2,2′-(ethylazanediyl)bis(ethan-1-ol), 2,2′-(butylazanediyl)bis(ethan-1-ol), 1-((2-hydroxyethyl)(methyl)amino)propan-2-ol, 1-(ethyl(2-hydroxyethyl)amino)propan-2-ol, 1-(butyl(2-hydroxyethyl)amino)propan-2-ol, 1,1′-(methylazanediyl)bis(propan-2-ol), 1,1′-(ethylazanediyl)bis(propan-2-ol), 1,1′-(butylazanediyl)bis(propan-2-ol), 1-((2-hydroxyethyl)(methyl)amino)-2-methylpropan-2-ol, 1-(ethyl(2-hydroxyethyl)amino)-2-methylpropan-2-ol, 1-(butyl(2-hydroxyethyl)amino)-2-methylpropan-2-ol, 1-(ethyl(2-hydroxypropyl)amino)-2-methylpropan-2-ol, 1-(butyl(2-hydroxypropyl)amino)-2-methylpropan-2-ol or mixtures thereof, preferably 1-((2-hydroxyethyl)(methyl)amino)-2-methylpropan-2-ol, 1-(ethyl(2-hydroxyethyl)amino)-2-methylpropan-2-ol and 1-(butyl(2-hydroxyethyl)amino)-2-methylpropan-2-ol or mixtures thereof, where it is preferable when the compound of the general formula (III) and the compound of the general formula (VI) are identical. The compounds of the general formulae (III) and (VI) are obtainable by customary synthesis routes. For example, in the case of the alkanolamines, these are obtainable, for example, in that corresponding epoxides geminally substituted by the respective radicals (R₁, R₂, R₃, R₄ or R₈, R₉, R₁₀, R₁₁) are reacted by methods known to the person skilled in the art with NH-functional compounds of the general formula H₂NR₅ or H₂NR₁₂ in a consecutive manner, optionally with isolation of the NH-functional intermediate of the formula R₅N(H)CH₂C(R₁,R₂)OH or R₁₂N(H)CH₂C(R₈,R₉)OH.

Tin-containing compounds that are suitable in accordance with the invention are generally tin(IV)-containing compounds. In a further embodiment of the process of the invention, it is also possible to use Sn(II) compounds. In this case, there follows an oxidative treatment of the resultant Sn(II) complex. Suitable apparatuses for this purpose are known per se to those skilled in the art. The tin-containing compound is more preferably selected from the group comprising or consisting of tin tetrachloride, tin tetrabromide, tin tetra-alkoxide, especially tin tetra-tert-butoxide, or mixtures thereof. Very particular preference is given in accordance with the invention to using tin tetra-tert-butoxide or tin tetrachloride. Moreover, it is preferable that the molar ratio of elemental tin or tin-containing compound to the sum total of the compounds having the general formulae (III) and (VI) is from 1:1 to 1:4, preferably from 1:1 to 1:2.1.

It is also possible by use of elemental tin (tin powder) to prepare the compound having the general formula (II), especially tin(IV) alkoxides. The preparation of tin(IV) alkoxides proceeding from elemental tin is described, for example, in DE 10 2010 012 237 A1.

It is preferable that the compounds having the general formulae (III) and (VI) are provided or initially charged in an appropriate reactor (for example stirred reactors having appropriate devices for the addition of reaction components etc.), optionally in a solvent, at a suitable temperature. Suitable solvents are selected, for example, from the group consisting of alcohols, preferably methanol, ethanol, propanol, especially isopropanol, or mixtures thereof, ethers, preferably diethyl ether, tetrahydrofuran, tert-butyl methyl ether or mixtures thereof, halogenated solvents, preferably dichloromethane, chloroform or mixtures thereof, aromatic solvents, preferably toluene, and mixtures thereof. The process of the invention is preferably effected within a temperature range between −30 and +150° C., more preferably −10 and 100° C., most preferably −10° C. and room temperature. It is further preferable when the process of the invention is conducted under an inert atmosphere, for example under nitrogen. In addition to the compounds having the general formulae (III) and (VI), further components may optionally be included in the initial charge. These are selected, for example, from auxiliary bases, for example alkoxides, and mixtures comprising these.

More preferably, the compounds having the general formulae (III) and (VI) are identical, and they are reacted with a tin-containing compound in order to obtain the catalyst of the general formula (II).

In a particularly preferred embodiment of the process of the invention, the at least one tin-containing compound is initially charged in an appropriate reactor, and the compound of the general formula (III) and the compound of the general formula (VI) are added in dilute form.

The resultant reaction solution may be worked up by methods known to the person skilled in the art, for example by filtration, distillative removal of the solvent, crystallization, etc.

### Formulation for Production of Polyisocyanate Polyaddition Products

The invention also relates to a formulation for production of polyisocyanate polyaddition products, comprising or consisting of the following components:
a) at least one aliphatic, (cyclo)aliphatic or aromatic polyisocyanate that is optionally substituted and/or has heteroatoms;
b) at least one compound of the invention as catalyst;
c) optionally further catalysts other than b);
d) optionally auxiliaries and/or additives,
   where the ratio of the weight of tin from component b) and the weight of component a) is preferably not more than 1000 ppm when component a) is an aliphatic and/or (cyclo)aliphatic polyisocyanate, and is not more than 50 ppm when component a) is an aromatic polyisocyanate.

The formulation preferably contains
5% to 80% by weight of component a);
0.0001% to 2.0% by weight of component b);
optionally 0.01% to 2.0% by weight of component c);
optionally 5% to 50% by weight of component d);
   based on the total weight of the formulation.

### Process for Production of Polyisocyanate Polyaddition Products

The compounds of the invention can be used for production of polyisocyanate polyaddition products. The present invention therefore provides a process for producing polyisocyanate polyaddition products by converting a composition:
comprising or consisting of at least one formulation as claimed in claim 16 or 17 and at least one NCO-reactive compound, where the reaction is preferably effected at an isocyanate index of 80 to 150,
   or
comprising or consisting of the following components:
A) at least one aliphatic, (cyclo)aliphatic or aromatic polyisocyanate that is optionally substituted and/or has heteroatoms;
B) at least one NCO-reactive compound;
C) at least one compound of the invention as catalyst;
D) optionally further catalysts other than C);
E) optionally auxiliaries and/or additives,
where the ratio of the weight of tin from component C) and the weight of component A) is preferably not more than 1000 ppm when component A) is an aliphatic and/or (cyclo)aliphatic polyisocyanate, and is not more than 50 ppm when component A) is an aromatic polyisocyanate.

The composition preferably contains
5% to 80% by weight of component A);
5% to 80% by weight of component B);
0.0001% to 2.0% by weight of component C);
optionally 0.01% to 2.0% by weight of component D);
optionally 5% to 50% by weight of component E);
   based on the total weight of the composition, and/or the reaction is effected at an isocyanate index of 80 to 150.

By the aforementioned process, consequently, a polyisocyanate polyaddition product has been obtained/is obtainable.

The isocyanate index (also known as the index or NCO/OH index) is understood to mean the quotient of the amount of substance [mol] of isocyanate groups actually used and the amount of substance [mol] of isocyanate-reactive groups actually used, multiplied by 100. In other words, the index indicates the percentage ratio of the amount of isocyanate actually used to the stoichiometric amount of isocyanate, i.e. the amount calculated for the conversion of the OH equivalents. An equivalent amount of NCO groups and NCO-reactive hydrogen atoms corresponds to an NCO/OH index of 100.

$$Index = [ ( moles of isocyanate groups ) / \\ ( moles of isocyanate - reactive groups ) ] * 100$$

The polyisocyanate polyaddition products are preferably polyurethanes. The individual components of the polyisocyanate polyaddition product of the invention, especially polyurethanes, are described in detail hereinafter.

The aliphatic, (cyclo)aliphatic or aromatic polyisocyanates a) or A) that are optionally substituted and/or have heteroatoms (also called polyisocyanate component hereinafter) and are suitable for the production of polyisocyanate polyaddition products and/or the formulation are the organic polyisocyanates having preferably at least two isocyanate groups per molecule that are known per se to the person skilled in the art, and mixtures thereof. Examples of polyisocyanates of this kind are di- or triisocyanates, for example butane diisocyanate, pentane diisocyanate (pentamethylene diisocyanate, PDI), hexane diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H₁₂MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H₆XDI), naphthalene 1,5-diisocyanate, diisocyanatodiphenylmethane (2,2′-, 2,4′- and 4,4′-MDI or mixtures thereof), diisocyanatomethylbenzene (tolylene 2,4- and 2,6-diisocyanate, TDI) and technical grade mixtures of the two isomers, and also 1,3-bis(isocyanatomethyl)benzene (XDI), 3,3′-dimethyl-4,4′-biphenyl diisocyanate (TODI), paraphenylene 1,4-diisocyanate (PPDI) and cyclohexyl diisocyanate (CHDI) and the oligomers of higher molecular weight that are obtainable individually or in a mixture from the above and have biuret, uretdione, isocyanurate, iminooxadiazinedione, allophanate, urethane and carbodiimide/uretonimine structural units. Very preferred is the use of polyisocyanates based on aliphatic and cycloaliphatic diisocyanates.

The polyisocyanate component a) and/or A) may be present in a suitable solvent. Suitable solvents are those that have sufficient solubility for the polyisocyanate component and are free of groups reactive toward isocyanates. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, solvent naphtha, 2-methoxypropyl acetate (MPA) and mixtures thereof.

The isocyanate component may additionally comprise customary auxiliaries and additives, for example rheology improvers (for example ethylene carbonate, propylene carbonate, dibasic esters, citric esters), stabilizers (for example Bronsted and Lewis acids, for instance hydrochloric acid, phosphoric acid, benzoyl chloride, organo mineral acids such as dibutyl phosphate, and also adipic acid, malic acid, succinic acid, pyruvic acid or citric acid), UV stabilizers (for example 2,6-dibutyl-4-methylphenol), hydrolysis stabilizers (for example sterically hindered carbodiimides), emulsifiers and catalysts (for example trialkylamines, diazabicyclooctane, tin dioctoate, dibutyltin dilaurate, N-alkylmorpholine, lead octoate, zinc octoate, tin octoate, calcium octoate, magnesium octoate, the corresponding naphthenates and p-nitrophenoxide and/or else mercury phenylneodecanoate) and fillers (for example chalk), dyes which may be incorporable into the polyurethane/polyurea to be formed at a later stage (which thus possess Zerewitinoff-active hydrogen atoms) and/or color pigments.

The NCO-reactive compounds B) used may preferably be any of the compounds which are known to those skilled in the art and have an average OH or NH functionality of at least 1.5. These may be, for example, low molecular weight diols (e.g. 1,2-ethanediol, 1,3- or 1,2-propanediol, 1,4-butanediol), triols (e.g. glycerol, trimethylolpropane) and tetraols (e.g. pentaerythritol), short-chain polyamines, but also higher molecular weight polyhydroxyl compounds such as polyether polyols, polyester polyols, polycarbonate polyols, polysiloxane polyols, polyamines and polyether polyamines and polybutadiene polyols.

Polyether polyols are obtainable in a manner known per se, by alkoxylation of suitable starter molecules under base catalysis or using double metal cyanide compounds (DMC compounds). Examples of suitable starter molecules for the preparation of polyether polyols are simple low molecular weight polyols, water, organic polyamines having at least two N—H bonds, or any mixtures of such starter molecules. Preferred starter molecules for the preparation of polyether polyols by alkoxylation, in particular by the DMC process, are in particular simple polyols such as ethylene glycol, propylene 1,3-glycol and butane-1, 4-diol, hexane-1,6-diol, neopentyl glycol, 2-ethylhexane-1,3-diol, glycerol, trimethylolpropane, pentaerythritol, and low molecular weight, hydroxyl group-containing esters of such polyols with dicarboxylic acids of the type specified hereinafter by way of example, or low molecular weight ethoxylation or propoxylation products of such simple polyols, or any desired mixtures of such modified or unmodified alcohols. Alkylene oxides suitable for the alkoxylation are especially ethylene oxide and/or propylene oxide, which can be used in the alkoxylation in any sequence or else in a mixture.

Polyester polyols can be prepared in a known manner by polycondensation of low-molecular-weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low-molecular-weight polyols, for example ethylene glycol, diethylene glycol, neopentyl glycol, hexanediol, butanediol, propylene glycol, glycerol, trimethylolpropane, 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as s-caprolactone. In addition, it is also possible to polycondense hydroxycarboxylic acid derivatives, for example lactic acid, cinnamic acid or ω-hydroxycaproic acid, to give polyester polyols. However, it is also possible to use polyester polyols of oleochemical origin. Such polyester polyols can be prepared for example by full ring-opening of epoxidized triglycerides of an at least partly olefinically unsaturated fatty acid-containing fat mixture with one or more alcohols having 1 to 12 carbon atoms and subsequent partial transesterification of the triglyceride derivatives to alkyl ester polyols having 1 to 12 carbon atoms in the alkyl radical.

The preparation of suitable polyacrylate polyols is known per se to those skilled in the art. They are obtained by free-radical polymerization of olefinically unsaturated monomers having hydroxyl groups or by free-radical copolymerization of olefinically unsaturated monomers having hydroxyl groups with optionally different olefinically unsaturated monomers, for example ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile, and/or methacrylonitrile. Suitable olefinically unsaturated monomers having hydroxyl groups are especially 2-hydroxyethyl acrylate, 2-hydroxyethyl methacrylate, the hydroxypropyl acrylate isomer mixture obtainable by addition of propylene oxide onto acrylic acid, and the hydroxypropyl methacrylate isomer mixture obtainable by addition of propylene oxide onto methacrylic acid. Suitable free-radical initiators are those from the group of the azo compounds, for example azoisobutyronitrile (AIBN), or from the group of the peroxides, for example di-tert-butyl peroxide.

Component B) preferably comprises higher molecular weight polyhydroxy compounds, for example having a molecular weight of 500 to 10 000 g/mol, preferably 1000 to 10 000 g/mol.

Component B) may be present in a suitable solvent. Suitable solvents are those that show sufficient solubility for the component. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, solvent naphtha, 2-methoxypropyl acetate (MPA) and mixtures thereof. In addition, the solvents may also bear groups that are reactive toward isocyanates. Examples of such reactive solvents are those that have an average functionality of groups reactive toward isocyanates of at least 1.8. These may be, for example, low molecular weight diols (e.g. ethane-1,2-diol, propane-1,3- or -1,2-diol, butane-1,4-diol), triols (e.g. glycerol, trimethylolpropane), but also low molecular weight diamines, for example polyaspartic esters.

In order to obtain the polyisocyanate polyaddition product of the invention and/or the formulation of the invention, at least one compound of the invention as catalyst is used as component b) or C).

The statements made with regard to the catalyst of the invention, especially with regard to preferred embodiments, are correspondingly applicable here. The catalyst of the invention may be added to the reaction mixture via the NCO-reactive compound (polyol), having been dissolved in a solvent and/or having been predissolved in the polyisocyanate.

The polyisocyanate polyaddition products of the invention or the formulation of the invention are additionally obtained with optional use of component D) or c), and further catalysts and/or activators other than C) or b), especially acids, amines, sterically hindered phenols, phosphites, etc. These are known per se to the person skilled in the art and are described, for example, in WO 2014/048879 A1. In addition, the catalyst of the invention may be combined with further catalysts/activators known from the prior art; for example, it is possible to use titanium catalysts, zirconium catalysts, bismuth catalysts, tin(II) catalysts and/or iron catalysts, as described, for example, in WO 2005/058996. It is also possible to add amines or amidines. In addition, in the polyisocyanate polyaddition reaction, it is also possible to add acidic compounds, for example 2-ethylhexanoic acid, or alcohols to control the reaction.

The polyisocyanate polyaddition products of the invention and/or the formulation of the invention are additionally obtained with optional use of component E) or d): fillers, pigments, additives, thickeners, defoamers and/or other auxiliaries and additives. Substances that are especially suitable as component E)/d) are selected from the group consisting of customary rheology improvers, stabilizers, UV stabilizers, hydrolysis stabilizers, emulsifiers, fillers, optionally incorporable dyes, i.e. those dyes having Zerewitinoff-active hydrogen atoms, color pigments and mixtures thereof. Preferred auxiliaries and additives in the production of the polyisocyanate polyaddition products are blowing agents, fillers, chalk, carbon black or zeolites, flame retardants, dye pastes, water, antimicrobials, flow improvers, thixotropic agents, surface modifiers, and retardants. Other auxiliaries and additives include defoamers, emulsifiers, foam stabilizers, and cell regulators. An overview is given in G. Oertel, Polyurethane Handbook, 2^{nd} edition, Carl Hanser Verlag, Munich, 1994, Ch. 3.4.

### Coating Composition

The polyisocyanate polyaddition products of the invention may be used in a wide variety of different applications. In particular, the present invention provides a coating composition for coating a substrate, comprising or consisting of at least one polyisocyanate polyaddition product of the invention, where the substrate is preferably a plastics part, a metal part or a shaped body made of wood.

The system of the invention, composed of the abovementioned components, can generally be applied to the substrate to be coated by any method known to the person skilled in the art, for example in solution or from the melt, and, in the case of powder coating, in solid form by methods such as painting, rolling, pouring, spraying, dipping, fluidized bed methods or electrostatic spraying methods. Examples of suitable substrates are materials such as metals, wood, plastics or ceramics.

### EMBODIMENTS

The present invention especially relates to the following embodiments:

In a first embodiment, the invention relates to a compound, especially a catalyst for production of polyisocyanate polyaddition products, having the general formula (I) or (II):

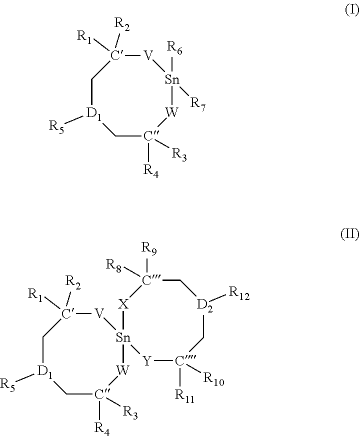

where
R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
R₅ and R₁₂ are independently aliphatic, (cyclo)aliphatic or aromatic radicals that are optionally substituted and/or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₂, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ and D₂ are independently oxygen, sulfur or nitrogen;
   characterized in that in formula (I) at least one of the R₁, R₂, R₃ or R₄ radicals is hydrogen and at least one of these radicals is not hydrogen, where the carbon atoms C′ and C″ do not bear the same radicals, and in formula (II) at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

In a second embodiment, the invention relates to a compound having the general formula (I) or (II) for use as catalyst in the production of polyisocyanate polyaddition products:

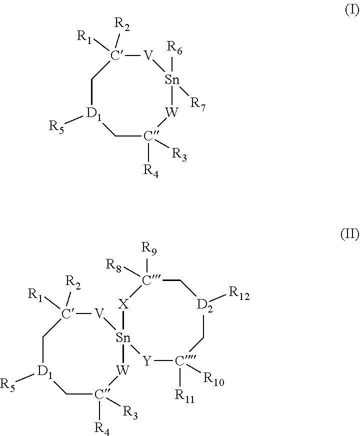

where
R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
R₅ and R₁₂ are independently aliphatic, (cyclo)aliphatic or aromatic radicals that are optionally substituted and/or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ and D₂ are independently oxygen, sulfur or nitrogen;
   characterized in that in formula (I) at least one of the R₁, R₂, R₃ or R₄ radicals is hydrogen and at least one of these radicals is not hydrogen, where the carbon atoms C′ and C″ do not bear the same radicals, and in formula (II) at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

In a third embodiment, the invention relates to a compound according to embodiment 1 or 2, characterized in that the at least one R₁, R₂, R₃ or R₄ radical in formula (I) that is not hydrogen and the at least one R₁, R₂, R₃, R₄, R₈, R₉, R₁₀ or R₁₁ radical in formula (II) that is not hydrogen is aliphatic and is preferably a methyl, ethyl, propyl, butyl, hexyl, octyl or perfluoroalkyl radical.

In a fourth embodiment, the invention relates to a compound according to any of the preceding embodiments, characterized in that R₅ and/or R₁₂ is a methyl, ethyl, propyl, butyl, pentyl, hexyl or octyl radical, preferably a methyl, butyl or ethyl radical.

In a fifth embodiment, the invention relates to a compound according to any of the preceding embodiments, characterized in that V, W, X and Y are oxygen and/or D₁ and D₂ are nitrogen.

In a sixth embodiment, the invention relates to a compound according to any of the preceding embodiments, characterized in that R₆ and R₇ are identical.

In a seventh embodiment, the invention relates to a compound of formula (II) according to embodiment 1, characterized in that the at least one R₁, R₂, R₃, R₄, R₈, R₉, R₁₀ or R₁₁ radical in formula (II) that is not hydrogen is a methyl, ethyl, propyl, butyl, hexyl, octyl or perfluoroalkyl radical, preferably a methyl radical, and in that R₅ and R₁₂ are independently aliphatic, (cyclo)aliphatic or aromatic radicals that are optionally substituted and/or have heteroatoms, are preferably the same and are a methyl, ethyl, propyl, butyl, pentyl, hexyl or octyl radical, and are more preferably the same and are a methyl, butyl or ethyl radical, and in that V, W, X and Y are oxygen and D₁ and D₂ are nitrogen.

In an eighth embodiment, the invention relates to a compound of formula (II) according to embodiment 1, characterized in that
R₁ is a methyl, ethyl, propyl, butyl, hexyl, octyl or perfluoroalkyl radical, preferably a methyl radical, and the R₂, R₃, R₄, R₈, R₉, R₁₀ and R₁₁ radicals are hydrogen,
or
R₁ and R₂ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₃, R₄, R₈, R₉, R₁₀ and R₁₁ radicals are hydrogen,
or
R₁ and R₁₀ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₂, R₃, R₄, R₈, R₉ and R₁₁ radicals are hydrogen,
or
R₁, R₂ and R₁₀ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₃, R₄, R₈, R₉ and R₁₁ radicals are hydrogen,
or
R₁, R₂, R₁₀ and R₁₁ are the same or different and are a methyl, ethyl, propyl, butyl, hexyl, octyl or perfluoroalkyl radical, are preferably the same and are a methyl, ethyl, propyl, butyl, hexyl, octyl or perfluoroalkyl radical, and are more preferably a methyl radical, and the R₃, R₄, R₅ and R₉ radicals are hydrogen,
and
in that R₅ and R₁₂ are independently aliphatic, (cyclo)aliphatic or aromatic radicals that are optionally substituted and/or have heteroatoms, are preferably the same and are a methyl, ethyl, propyl, butyl, pentyl, hexyl or octyl radical, and are more preferably the same and are a methyl, butyl or ethyl radical,
and in that V, W, X and Y are oxygen and D₁ and D₂ are nitrogen.

In a ninth embodiment, the invention relates to a compound according to embodiment 1, characterized in that the compound is selected from the group comprising or consisting of
2,2-dichloro-4,6-dimethyl-1,3,6,2-dioxazastannocane, 2,2-dibromo-4,6-dimethyl-1,3,6,2-dioxazastannocane, 2,2-dimethoxy-4,6-dimethyl-1,3,6,2-dioxazastannocane, 4,6-dimethyl-1,3,6,2-dioxazastannocane-2,2-diyl dibenzoate, 6-ethyl-4-methyl-1,3,6,2-dioxazastannocane-2,2-diyl dibenzoate, 6-butyl-4-methyl-1,3,6,2-dioxazastannocane-2,2-diyl dibenzoate, 2,4,12-trimethyl-1,7,9,15-tetraoxa-4,12-diaza-8-stannaspiro[7.7]pentadecane, 2,2,4,12-tetramethyl-1,7,9,15-tetraoxa-4,12-diaza-8-stannaspiro[7.7]pentadecane, 2,4,10,12-tetramethyl-1,7,9,15-tetraoxa-4,12-diaza-8-stannaspiro[7.7]pentadecane, 2,2,4,10,12-pentamethyl-1,7,9,15-tetraoxa-4,12-diaza-8-stannaspiro[7.7]pentadecane, 2,2,4,10,10,12-hexamethyl-1,7,9,15-tetraoxa-4,12-diaza-8-stannaspiro[7.7]pentadecane, 2,2,4,6,10,10,12-heptamethyl-1,7,9,15-tetraoxa-4,12-diaza-8-stannaspiro[7.7]pentadecane, 2,2,4,6,6,10,10,12-octamethyl-1,7,9,15-tetraoxa-4,12-diaza-8-stannaspiro[7.7]pentadecane, 2,2,4,6,6,10,10,12,14-nonamethyl-1,7,9,15-tetraoxa-4,12-diaza-8-stannaspiro[7.7]pentadecane, 4,12-diethyl-2-methyl-1,7,9,15-tetraoxa-4,12-diaza-8-stannaspiro[7.7]pentadecane, 4,12-diethyl-2,2-dimethyl-1,7,9,15-tetraoxa-4,12-diaza-8-stannaspiro[7.7]pentadecane, 4,12-diethyl-2,10-dimethyl-1,7,9,15-tetraoxa-4,12-diaza-8-stannaspiro[7.7]pentadecane, 4,12-diethyl-2,2,10-trimethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-diethyl-2,2,6,10,10-pentamethyl-1,7,9,15-tetraoxa-4,12-diaza-8-stannaspiro[7.7]pentadecane, 4,12-diethyl-2,2,6,6,10,10-hexamethyl-1,7,9,15-tetraoxa-4,12-diaza-8-stannaspiro[7.7]pentadecane, 4,12-diethyl-2,2,6,6,10,10,14-heptamethyl-1,7,9,15-tetraoxa-4,12-diaza-8-stannaspiro[7.7]pentadecane, 4,12-dibutyl-2-methyl-1,7,9,15-tetraoxa-4,12-diaza-8-stannaspiro[7.7]pentadecane, 4,12-dibutyl-2,2-dimethyl-1,7,9,15-tetraoxa-4,12-diaza-8-stannaspiro[7.7]pentadecane, 4,12-dibutyl-2,10-dimethyl-1,7,9,15-tetraoxa-4,12-diaza-8-stannaspiro[7.7]pentadecane, 4,12-dibutyl-2,2,10-trimethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dibutyl-2,2,6,10,10-pentamethyl-1,7,9,15-tetraoxa-4,12-diaza-8-stannaspiro[7.7]pentadecane, 4,12-dibutyl-2,2,6,6,10,10-hexamethyl-1,7,9,15-tetraoxa-4,12-diaza-8-stannaspiro[7.7]pentadecane, 4,12-dibutyl-2,2,6,6,10,10,14-heptamethyl-1,7,9,15-tetraoxa-4,12-diaza-8-stannaspiro[7.7]pentadecane, 4,12-dibutyl-2-(trifluoromethyl)-1,7,9,15-tetraoxa-4,12-diaza-8-stannaspiro[7.7]pentadecane, 4,12-dibutyl-2,10-bis(trifluoromethyl)-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof,
preferably 2,4,12-trimethyl-1,7,9,15-tetraoxa-4,12-diaza-8-stannaspiro[7.7]pentadecane, 2,2,4,12-tetramethyl-1,7,9,15-tetraoxa-4,12-diaza-8-stannaspiro[7.7]pentadecane, 2,4,10,12-tetramethyl-1,7,9,15-tetraoxa-4,12-diaza-8-stannaspiro[7.7]pentadecane, 2,2,4,10,12-pentamethyl-1,7,9,15-tetraoxa-4,12-diaza-8-stannaspiro[7.7]pentadecane, 2,2,4,10,10,12-hexamethyl-1,7,9,15-tetraoxa-4,12-diaza-8-stannaspiro[7.7]pentadecane, 2,2,4,6,10,10,12-heptamethyl-1,7,9,15-tetraoxa-4,12-diaza-8-stannaspiro[7.7]pentadecane, 2,2,4,6,6,10,10,12-octamethyl-1,7,9,15-tetraoxa-4,12-diaza-8-stannaspiro[7.7]pentadecane, 2,2,4,6,6,10,10,12,14-nonamethyl-1,7,9,15-tetraoxa-4,12-diaza-8-stannaspiro[7.7]pentadecane, 4,12-diethyl-2-methyl-1,7,9,15-tetraoxa-4,12-diaza-8-stannaspiro[7.7]pentadecane, 4,12-diethyl-2,2-dimethyl-1,7,9,15-tetraoxa-4,12-diaza-8-stannaspiro[7.7]pentadecane, 4,12-diethyl-2,10-dimethyl-1,7,9,15-tetraoxa-4,12-diaza-8-stannaspiro[7.7]pentadecane, 4,12-diethyl-2,2,10-trimethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-diethyl-2,2,6,10,10-pentamethyl-1,7,9,15-tetraoxa-4,12-diaza-8-stannaspiro[7.7]pentadecane, 4,12-diethyl-2,2,6,6,10,10-hexamethyl-1,7,9,15-tetraoxa-4,12-diaza-8-stannaspiro[7.7]pentadecane, 4,12-diethyl-2,2,6,6,10,10,14-heptamethyl-1,7,9,15-tetraoxa-4,12-diaza-8-stannaspiro[7.7]pentadecane, 4,12-dibutyl-2-methyl-1,7,9,15-tetraoxa-4,12-diaza-8-stannaspiro[7.7]pentadecane, 4,12-dibutyl-2,2-dimethyl-1,7,9,15-tetraoxa-4,12-diaza-8-stannaspiro[7.7]pentadecane, 4,12-dibutyl-2,10-dimethyl-1,7,9,15-tetraoxa-4,12-diaza-8-stannaspiro[7.7]pentadecane, 4,12-dibutyl-2,2,10-trimethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dibutyl-2,2,6,10,10-pentamethyl-1,7,9,15-tetraoxa-4,12-diaza-8-stannaspiro[7.7]pentadecane, 4,12-dibutyl-2,2,6,6,10,10-hexamethyl-1,7,9,15-tetraoxa-4,12-diaza-8-stannaspiro[7.7]pentadecane, 4,12-dibutyl-2,2,6,6,10,10,14-heptamethyl-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof,
   more preferably 2,2,4,10,10,12-hexamethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof,
   most preferably 2,2,4,10,10,12-hexamethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane or mixtures thereof.

In a tenth embodiment, the invention relates to a process for producing a compound having the general formula (I) according to any of embodiments 1 to 9 by reaction of either
a tin-containing compound of the R₆R₇SnZ₂ type with
a compound of the general formula (III):

HV—C′(R₁;R₂)—CH₂-D₁(R₅)—CH₂—C″(R₃;R₄)—WH (III)

or
a tin-containing compound of the SnZ₄ type with
a compound of the general formula (III); and

HV—C′(R₁;R₂)—CH₂-D₁(R₅)—CH₂—C″(R₃;R₄)—WH (III)
and then with compounds of the general formulae (IV) and (V):

R₆-A (IV)

R₇-A (V)

where
R₁, R₂, R₃, R₄ are independently hydrogen or are aliphatic, (cyclo)aliphatic or aromatic radicals that are optionally substituted and/or have heteroatoms;
R₅ is independently aliphatic, (cyclo)aliphatic or aromatic radicals that are optionally substituted and/or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted and/or have heteroatoms;
V and W are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ is oxygen, sulfur or nitrogen;
A is leaving groups, preferably —OH, —SH, N(R₂₂)H— or halogens, where R₂₂ is aliphatic, (cyclo)aliphatic or aromatic radicals that are optionally substituted and/or have heteroatoms;
Z is halogens, alkoxides or mixtures thereof;
   characterized in that at least one of the R₁, R₂, R₃ or R₄ radicals is hydrogen and at least one of these radicals is not hydrogen, where the carbon atoms C′ and C″ do not bear the same radicals.

In an eleventh embodiment, the invention relates to a process according to embodiment 10, characterized in that
the compound of the general formula (III) comprises or consists of 2,2′-(methylazanediyl)bis(ethan-1-ol), 2,2′-(ethylazanediyl)bis(ethan-1-ol), 2,2′-(butylazanediyl)bis(ethan-1-ol), 1-((2-hydroxyethyl)(methyl)amino)propan-2-ol, 1-(ethyl(2-hydroxyethyl)amino)propan-2-ol, 1-(butyl(2-hydroxyethyl)amino)propan-2-ol, 1,1′-(methylazanediyl)bis(propan-2-ol), 1,1′-(ethylazanediyl)bis(propan-2-ol), 1,1′-(butylazanediyl)bis(propan-2-ol), 1-((2-hydroxyethyl)(methyl)amino)-2-methylpropan-2-ol, 1-(ethyl(2-hydroxyethyl)amino)-2-methylpropan-2-ol, 1-(butyl(2-hydroxyethyl)amino)-2-methylpropan-2-ol, 1-(ethyl(2-hydroxypropyl)amino)-2-methylpropan-2-ol, 1-(butyl(2-hydroxypropyl)amino)-2-methylpropan-2-ol or mixtures thereof, preferably 1-((2-hydroxyethyl)(methyl)amino)-2-methylpropan-2-ol, 1-(ethyl(2-hydroxyethyl)amino)-2-methylpropan-2-ol, 1-(butyl(2-hydroxyethyl)amino)-2-methylpropan-2-ol or mixtures thereof; and/or
   the compound of the general formula (IV) and/or of the general formula (V) comprises or consists of halogen, halides, alkoxides, carboxylates, peroxides, disulfides or mixtures thereof.

In a twelfth embodiment, the invention relates to a process according to embodiment 10 or 11, characterized in that the tin-containing compound of the SnZ₄ type is selected from the group comprising or consisting of tin tetrachloride, tin tetrabromide, tin tetra-tert-alkoxide, especially tin tetra-tert-butoxide, and mixtures thereof.

In a thirteenth embodiment, the invention relates to a process according to any of embodiments 10 to 12, characterized in that the molar ratio of tin-containing compound to the sum total of the compounds having the general formulae (III), (IV) and (V) is from 1:1 to 1:4, preferably from 1:1 to 1:2.1.

In a fourteenth embodiment, the invention relates to a process for producing a compound having the general formula (I) according to any of embodiments 1 to 9 by reaction of elemental tin or a tin-containing compound with
a compound having the general formula (III); and

HV—C′(R₁;R₂)—CH₂-D₁(R₅)—CH₂—C″(R₃;R₄)—WH (III)
a compound having the general formula (IV);

HX—C″′(R₈;R₉)—CH₂-D₂(R₁₂)—CH₂—C″″(R₁₀;R₁₁)—YH (VI);

where
R₁, R₂, R₃, R₄, R₈, R₉, R₁₀ and R₁₁ are independently hydrogen or are aliphatic, (cyclo)aliphatic or aromatic radicals that are optionally substituted and/or have heteroatoms;
R₅ and R₁₂ are independently aliphatic, (cyclo)aliphatic or aromatic radicals that are optionally substituted and/or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted and/or have heteroatoms;
D₁ and D₂ are independently oxygen, sulfur or nitrogen;
   characterized in that at least one of the R₁, R₂, R₃, R₄, R₈, R₉, R₁₀ or R₁₁ radicals is hydrogen and at least one of these radicals is not hydrogen, where the carbon atoms C′ and C″ and/or C′ and C″″ do not bear the same radicals.

In a fifteenth embodiment, the invention relates to a process according to embodiment 14, characterized in that the compound of the general formula (III) and/or the compound of the general formula (VI) comprises or consists of 2,2′-(methylazanediyl)bis(ethan-1-ol), 2,2′-(ethylazanediyl)bis(ethan-1-ol), 2,2′-(butylazanediyl)bis(ethan-1-ol), 1-((2-hydroxyethyl)(methyl)amino)propan-2-ol, 1-(ethyl(2-hydroxyethyl)amino)propan-2-ol, 1-(butyl(2-hydroxyethyl)amino)propan-2-ol, 1,1′-(methylazanediyl)bis(propan-2-ol), 1,1′-(ethylazanediyl)bis(propan-2-ol), 1,1′-(butylazanediyl)bis(propan-2-ol), 1-((2-hydroxyethyl)(methyl)amino)-2-methylpropan-2-ol, 1-(ethyl(2-hydroxyethyl)amino)-2-methylpropan-2-ol, 1-(butyl(2-hydroxyethyl)amino)-2-methylpropan-2-ol, 1-(ethyl(2-hydroxypropyl)amino)-2-methylpropan-2-ol, 1-(butyl(2-hydroxypropyl)amino)-2-methylpropan-2-ol or mixtures thereof, preferably 1-((2-hydroxyethyl)(methyl)amino)-2-methylpropan-2-ol, 1-(ethyl(2-hydroxyethyl)amino)-2-methylpropan-2-ol and 1-(butyl(2-hydroxyethyl)amino)-2-methylpropan-2-ol or mixtures thereof, where it is preferable when the compound of the general formula (III) and the compound of the general formula (VI) are identical.

In a sixteenth embodiment, the invention relates to a process according to embodiment 14 or 15, characterized in that the tin-containing compound is selected from the group comprising or consisting of tin tetrachloride, tin tetrabromide, tin tetra-alkoxide, especially tin tetra-tert-butoxide, or mixtures thereof.

In a seventeenth embodiment, the invention relates to a process according to any of embodiments 14 and 16, characterized in that the molar ratio of elemental tin or tin-containing compound to the sum total of the compounds having the general formulae (III) and (VI) is from 1:1 to 1:4, preferably from 1:1 to 1:2.1.

In an eighteenth embodiment, the invention relates to the use of a compound as claimed in any of claims 1 to 9 as catalyst, preferably as thermolatent catalyst for production of polyisocyanate polyaddition products, especially polyurethanes, preferably polyurethane foams, polyurethane coatings, polyurethane paints or polyurethane adhesives.

In a nineteenth embodiment, the invention relates to a formulation for production of polyisocyanate polyaddition products, comprising or consisting of the following components:
a) at least one aliphatic, (cyclo)aliphatic or aromatic polyisocyanate that is optionally substituted and/or has heteroatoms;
b) at least one compound according to any of embodiments 1 to 9 as catalyst;
c) optionally further catalysts other than b);
d) optionally auxiliaries and/or additives,
   where the ratio of the weight of tin from component b) and the weight of component a) is preferably not more than 1000 ppm when component a) is an aliphatic and/or (cyclo)aliphatic polyisocyanate, and is not more than 50 ppm when component a) is an aromatic polyisocyanate.

In a twentieth embodiment, the invention relates to a formulation according to embodiment 19, characterized in that the formulation contains
5% to 80% by weight of component a);
0.0001% to 2.0% by weight of component b);
optionally 0.01% to 2.0% by weight of component c);
optionally 5% to 50% by weight of component d);
   based on the total weight of the formulation.

In a twenty-first embodiment, the invention relates to a process for producing polyisocyanate polyaddition products by reaction of a composition:
comprising or consisting of at least one formulation according to embodiment 19 or 20 and at least one NCO-reactive compound, where the reaction is preferably effected at an isocyanate index of 80 to 150,
   or
comprising or consisting of the following components:
A) at least one aliphatic, (cyclo)aliphatic or aromatic polyisocyanate that is optionally substituted and/or has heteroatoms;
B) at least one NCO-reactive compound;
C) at least one compound according to any of embodiments 1 to 9 as catalyst;
D) optionally further catalysts other than C);
E) optionally auxiliaries and/or additives,
where the ratio of the weight of tin from component C) and the weight of component A) is preferably not more than 1000 ppm when component A) is an aliphatic and/or (cyclo)aliphatic polyisocyanate, and is not more than 50 ppm when component A) is an aromatic polyisocyanate.

In a twenty-second embodiment, the invention relates to a process according to embodiment 21, characterized in that the composition contains
5% to 80% by weight of component A);
5% to 80% by weight of component B);
0.0001% to 2.0% by weight of component C);
optionally 0.01% to 2.0% by weight of component D);
optionally 5% to 50% by weight of component E);
   based on the total weight of the composition, and/or in that the reaction is effected at an isocyanate index of 80 to 150.

In a twenty-third embodiment, the invention relates to a polyisocyanate polyaddition product, obtained or obtainable by a process according to embodiment 21 or 22.

In a twenty-fourth embodiment, the invention relates to a coating composition for coating a substrate, comprising or consisting of at least one polyisocyanate polyaddition product according to embodiment 22, where the substrate is preferably a plastics part, a metal part or a shaped body made of wood.

### Examples and Comparative Examples

The present invention will now be elucidated with reference to examples, but is not limited thereto.

In the examples, all percentages are to be understood as meaning percent by weight, unless otherwise stated. All reactions were carried out under an atmosphere of dry nitrogen. The preparation of the inventive catalysts and comparative catalysts listed in table 1, the synthesis of the ligands used for production thereof and the provision of the thermolatently catalyzed polyisocyanate curing agent formulations used is described in detail in WO 2021/249887 A1.

For better comparability of the activity of the activity of the catalysts to be used in accordance with the invention and the catalysts from the comparative examples, the amount of catalyst was reported as mg of Sn per kg of polyisocyanate curing agent (ppm), using, as polyisocyanate curing agent, the commercial product Desmodur ultra N 3300 (HC content 5 ppm) from Covestro AG, Leverkusen, D, NCO content 21.8%, and, as model compound for the isocyanate-reactive component (‘poly’ol), exactly one equivalent, based on the free isocyanate groups of the polyisocyanate curing agent, of triethylene glycol monoemthyl ether (product from Aldrich, Taufkirchen, Germany). Addition of 10% (based on Desmodur ultra N 3300) of n-butyl acetate ensured that, over the entire course of the reaction, samples of sufficiently low viscosity could be taken, which permit exact detection of the NCO content by titration according to DIN 53 185. The NCO content calculated at the start of the reaction without any NCO—OH reaction is 11.1% and is normalized here to 100% as starting value. All titrated values are normalized thereto in table 2.

Comparative experiment 1 at a constant 30° C. shows the extremely slow decrease in the NCO content of the mixture in the uncatalyzed case (table 2, experiment 1). In order to enable comparison of the acceleration of the reaction at reaction temperature 50° C. (referred to in the real paint system as ‘curing temperature’), a series of experiments was additionally conducted, at first likewise without catalysis, firstly at a constant 30° C. (2 h) and then 50° C. (table 2, experiment 2). All comparative experiments 3 to 7 and the inventive examples (8 upward) were run according to the same regime: initially 2 h at 30° C. for assessment of thermolatency and then 50° C. for assessment of the reactivity at ‘curing temperature’.

TABLE 1
Overview of the catalysts used; 1-3 comparative, 4 upward inventive

| Catalyst | IUPAC name¹⁾ |
|---|---|
| 1 | 4,12-dibutyl-1,7,9,15-tetraoxa-4,12-diaza-8-stannaspiro[7.7]pentadecane |
| 2 | 4,12-dibutyl-2,6,10,14-tetramethyl-1,7,9,15-tetraoxa-4,12-diaza-8- |
| | stannaspiro[7.7]pentadecane |
| 3 | 4,12-dibutyl-2,2,6,6,10,10,14,14-octamethyl-1,7,9,15-tetraoxa-4,12-diaza-8- |
| | stannaspiro[7.7]pentadecane |
| 4 | 4,12-dibutyl-2,2,10,10-tetramethyl-1,7,9,15-tetraoxa-4,12-diaza-8- |
| | stannaspiro[7.7]pentadecane |
| 5 | 4,12-dibutyl-2,2,10-trimethyl-1,7,9,15-tetraoxa-4,12-diaza-8- |
| | stannaspiro[7.7]pentadecane |
| 6 | 4,12-dibutyl-2,10-dimethyl-1,7,9,15-tetraoxa-4,12-diaza-8-stannaspiro[7.7]pentadecane |
| 7 | 4,12-dibutyl-2,2-dimethyl-1,7,9,15-tetraoxa-4,12-diaza-8-stannaspiro[7.7]pentadecane |
| 8 | 4,12-dibutyl-2-methyl-1,7,9,15-tetraoxa-4,12-diaza-8-stannaspiro[7.7]pentadecane |
| 9 | 2,2,4,10,10,12-hexamethyl-1,7,9,15-tetraoxa-4,12-diaza-8-stannaspiro[7.7]pentadecane |

¹⁾the IUPAC names were generated by the ChemDraw Professional Version 20.1.1125 program.

TABLE 2
Overview of the experiments conducted
(examples 1-7: comparative examples, examples 8-15: inventive)

| | | | NCO content of the mixture [% rel.] after [hh:mm] | | | | | | | | | |
|---|---|---|---|---|---|---|---|---|---|---|---|---|
| Ex. | | Cat. | normalized to the calculated start value = 100% | | | | | | | | | |
| No. | Cat. | conc.¹⁾ | 00:30 | 1:00 | 1:30 | 2:00 | 2:10 | 2:20 | 2:30 | 3:00 | 4:00 | 6:00 |
| 1 | none | 0²⁾ | 100 | 99.9 | 99.8 | 99.6 | 99.6 | 99.5 | 99.5 | 99.4 | 99.4 | 99.2 |
| 2 | none | 0³⁾ | 100 | 100 | 99.7 | 99.6 | 99.5 | 98 | 97.5 | 96.2 | 92.3 | 85.3 |
| 3 | Cat. 1 | 20³⁾ | 100 | 99.9 | 99.8 | 99.6 | 96.6 | 94.1 | 93.5 | 87.2 | 82.4 | 72.1 |
| 4 | Cat. 1 | 60³⁾ | 100 | 98.2 | 97.4 | 97.2 | 91.8 | 90.5 | 89 | 82.6 | 56.9 | 37.2 |
| 5 | Cat. 2 | 20³⁾ | 100 | 99.8 | 99.9 | 99.8 | 96.7 | 94.8 | 93.8 | 87 | 74.4 | 56.8 |
| 6 | Cat. 2 | 60³⁾ | 99.8 | 97.9 | 96.2 | 95.9 | 88.8 | 86.4 | 85.9 | 82.6 | 56.9 | 22.3 |
| 7 | Cat. 3 | 60³⁾ | 99.7 | 99.4 | 99.2 | 98.8 | 97.1 | 95.2 | 94.6 | 87.2 | 82.6 | 73.4 |
| 8 | Cat. 4 | 20³⁾ | 99.6 | 98.5 | 97.2 | 96.8 | 87.4 | 85.1 | 81.1 | 77.7 | 54.1 | 18.9 |
| 9 | Cat. 5 | 20³⁾ | 99.7 | 97.5 | 96.3 | 95.4 | 88.4 | 86.6 | 82.1 | 79.2 | 57.2 | 28.6 |
| 10 | Cat. 6 | 20³⁾ | 99.7 | 97.8 | 96.2 | 95.7 | 88.8 | 86.4 | 85.2 | 81.2 | 59.1 | 32.1 |
| 11 | Cat. 7 | 20³⁾ | 99.4 | 97.9 | 96.3 | 95.9 | 89.2 | 86.4 | 86.2 | 82 | 62.3 | 33.3 |
| 12 | Cat. 8 | 20³⁾ | 99.5 | 98 | 96.5 | 95.9 | 94.8 | 93.2 | 88.8 | 83.3 | 65.5 | 48.9 |
| 13 | Cat. 8 | 60³⁾ | 99.8 | 97.9 | 96.2 | 95.9 | 88.8 | 85.8 | 82 | 76.4 | 50.1 | 18.9 |
| 15 | Cat. 9 | 20³⁾ | 99.5 | 98.4 | 97.0 | 96.6 | 87.2 | 84.9 | 80.0 | 76.2 | 48.1 | 16.7 |

¹⁾Sn [ppm] based on polyisocyanate curing agent
²⁾constant at 30° C.
³⁾first 2 h at 30° C., then 50° C. - see text

As can be seen from the results shown in table 2, all systems—irrespective of whether they are inventive or not—are sufficiently unreactive at 30° C. to be considered to be thermolatent. However, the systems of the invention with an “unsymmetric” ligand environment of the central atom at 50° C. display a much higher activity in some cases than is observed for the comparative systems based on catalysts 1-3. It is surprising in view of the very low reactivity of compound 3 and the moderate reactivity of compound 1 that compound 4, which is effectively a “combination” of the ligand environments of 1 and 3, is much more reactive than the two comparative catalysts. The person skilled in the art here would have expected reactivity between that of 1 and 3.

### Examples 16-21: Experiment Series for Assessment of Color Stability

Catalysts 1, 2 and 4 according to table 1 were firstly dissolved in hexamethylene diisocyanate (HC content 25 ppm), choosing the catalyst concentration so as to result in each case in mixtures containing a uniform 0.1% tin (examples 16-18), and secondly blended as 10% solutions in n-butyl acetate (BA) with heating (50° C.) together with the Covestro Desmodur N 3900 polyisocyanate that contains iminooxadiazinedione groups (HC content 16 ppm) in such an amount as to result in a uniform 750 ppm of tin based on solvent-free Desmodur N 3900, which was then diluted to 90% solids by adding further butyl acetate (examples 19-21).

Hazen color number was measured by spectrophotometry according to DIN EN ISO 6271-2:2005-03 with a LICO 400 spectrophotometer from Lange, Germany.

These mixtures were stored at 50° C. under nitrogen, and the evolution of color was monitored; cf. table 3.

TABLE 3
Overview of the experiments conducted with regard to evolution
of color of HDI (0.1% Sn) and Desmodur N 3900 (750 ppm of Sn
based on polyisocyanate) (examples 16 and 17, and 19 and 20:
comparative examples, examples 18 and 21: inventive)

Example

| | | | | | |
|---|---|---|---|---|---|
| 16 | 17 | 18 | 19 | 20 | 21 |

Catalyst

| | | | | | | |
|---|---|---|---|---|---|---|
| Days at | 1 | 2 | 4 | 1 | 2 | 4 |

| | |
|---|---|
| 50° C. | Hazen color number [Apha] |

| | | | | | | |
|---|---|---|---|---|---|---|
| 0 | 9 | 18 | 5 | 32 | 34 | 35 |
| 4 | 128 | 236 | 13 | 32 | 31 | 19 |
| 5 | 158 | 339 | 19 | 33 | 54 | 20 |
| 6 | 169 | 385 | 19 | 37 | 119 | 20 |
| 7 | 185 | 453 | 26 | 45 | 184 | 19 |
| 11 | 231 | 666 | 43 | 68 | 396 | 24 |
| 13 | 246 | 746 | 61 | 80 | 461 | 22 |
| 14 | 256 | 772 | 76 | 88 | 485 | 22 |
| 15 | 265 | 818 | 89 | 98 | 527 | 22 |
| 19 | 310 | 974 | 122 | 145 | 653 | 28 |
| 21 | | | | 169 | 707 | 29 |
| 25 | | | | 169 | 707 | 29 |
| 27 | | | | 227 | 773 | 46 |
| 28 | | | | 277 | 825 | 59 |

As can be seen, the inventive system based on catalyst 4 is distinctly superior to the structurally similar comparative systems (catalyst 2 is merely a positional isomer of 4!) with regard to the color stability of the isocyanate adducts as well.

### Examples 22-27: Experiment Series for Assessment Of Color Stability

Catalysts 1, 2, 4 and 9 according to table 1 were firstly dissolved in bis(4-isocyanatocyclohexyl)methane (isomer mixture, Desmodur W product from Covestro, HC content <5 ppm, detection limit of the method chosen), choosing the catalyst concentration so as to result in each case in mixtures containing a uniform 0.1% tin (examples 22-25), and secondly catalysts 2 and 4 were blended as 10% solutions in n-butyl acetate (BA) with heating (50° C.) together with the Covestro Desmodur CQ U N 7300 polyisocyanate (HC content 12 ppm) in such an amount as to result in a uniform 750 ppm of tin based on solvent-free Desmodur CQ U N 7300, which was then diluted to 90% solids by adding further butyl acetate (examples 26-29).

Hazen color number was measured by spectrophotometry according to DIN EN ISO 6271-2:2005-03 with a LICO 400 spectrophotometer from Lange, Germany.

These mixtures were stored at 50° C. under nitrogen, and the evolution of color was monitored; cf. table 4.

TABLE 4
Overview of the experiments conducted with regard to evolution
of color of Desmodur W (0.1% Sn) and Desmodur CQ U N 7300
(750 ppm of Sn based on polyisocyanate) (examples 22, 23 and 26:
comparative examples, examples 24, 25 and 27: inventive)

Example

| | | | | | |
|---|---|---|---|---|---|
| 22 | 23 | 24 | 25 | 26 | 27 |

Catalyst

| | | | | | | |
|---|---|---|---|---|---|---|
| Days at | 1 | 2 | 4 | 9 | 2 | 4 |

| | |
|---|---|
| 50° C. | Hazen color number [Apha] |

| | | | | | | |
|---|---|---|---|---|---|---|
| 0 | 10 | 26 | 6 | 6 | 14 | 15 |
| 3 | 34 | 8 | 8 | 23 | 19 | 15 |
| 7 | 49 | 10 | 10 | 30 | 24 | 17 |
| 21 | 84 | 42 | 17 | 50 | 39 | 16 |
| 31 | 92 | 50 | 29 | 58 | 55 | 18 |
| 40 | 97 | 55 | 24 | 58 | 66 | 16 |
| 51 | 109 | 59 | 47 | 68 | 86 | 20 |
| 66 | 127 | 80 | 40 | 80 | 126 | 19 |
| 76 | 129 | 82 | 41 | 78 | 212 | 19 |
| 80 | 132 | 86 | 40 | 80 | 274 | 19 |
| 97 | 132 | 95 | 40 | 82 | 590 | 24 |
| 105 | 136 | 111 | 39 | 86 | 724 | 28 |
| 111 | 143 | 118 | 43 | 91 | | 28 |
| 115 | 147 | 117 | 48 | 95 | | 30 |
| 122 | 152 | 126 | 50 | 98 | | 34 |
| 129 | 163 | 121 | 57 | 102 | | 38 |
| 136 | 172 | 132 | 64 | 105 | | 40 |
| 143 | 176 | 153 | 76 | 109 | | 41 |
| 147 | | 159 | 96 | 110 | | 41 |
| 151 | | 161 | 90 | 143 | | 41 |
| 152 | | | 96 | 134 | | 41 |
| 153 | | | 92 | 131 | | 41 |
| 154 | | | 100 | 131 | | 43 |
| 157 | | | 102 | 132 | | 43 |
| 158 | | | 95 | 134 | | 43 |
| 159 | | | 101 | 139 | | 44 |
| 160 | | | 104 | 133 | | 43 |
| 161 | | | 104 | 142 | | 43 |
| 165 | | | 107 | 149 | | 46 |
| 166 | | | 100 | 145 | | 47 |
| 176 | | | | | | 49 |
| 181 | | | | | | 54 |

As can be seen, the products of the invention based on catalysts 4 and 9 are distinctly superior to the structurally similar comparative products (catalyst 2 is merely a positional isomer of 4!) with regard to the color stability of these isocyanate adducts as well. Without wishing to be bound to any theory, it seems to be plausible to assume that the lower residual halogen contents (detected by the HC content) of the isocyanates used here (comparing the results obtained with Desmodur W and HDI in particular) generally have a positive effect on color stability, and the catalysts used in accordance with the invention (4 and 9) again show distinctly better results than the comparative systems from the prior art (1 and 2).

1. A compound of the general formula (I) or (II): 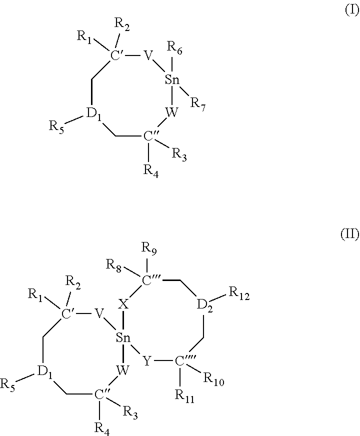
where
R₁, R₂, R₃, R₄, R₈, R₉, R₁₀ and R₁₁ are independently hydrogen or are aliphatic, (cyclo)aliphatic or aromatic radicals that are optionally substituted or have heteroatoms;
R₅ and R₁₂ are independently aliphatic, (cyclo)aliphatic or aromatic radicals that are optionally substituted or have heteroatoms;
R₆ and R₇ are independently —OH, —SH, —OR₁₃, halogens, —OC(═O)R₁₄, —SR₁₅, —OC(═S)R₁₆, —OS(═O)₂OR₁₇, —OS(═O)₂R₁₈ or —NR₁₉R₂₀, where R₁₃ to R₂₀ are independently aliphatic, (cyclo)aliphatic or aromatic radicals that are optionally substituted or have heteroatoms;
V, W, X and Y are independently oxygen, sulfur, —OC(═O)—, —OC(═S)—, —SC(═O)—, —SC(═S)—, —OS(═O)₂O—, —OS(═O)₂— or —N(R₂₁)—, where R₂₁ is aliphatic, (cyclo)aliphatic or aromatic radicals that are optionally substituted or have heteroatoms;
D₁ and D₂ are independently oxygen, sulfur or nitrogen;
wherein in formula (I) at least one of the R₁, R₂, R₃ or R₄ radicals is hydrogen and at least one of these radicals is not hydrogen, where the carbon atoms C′ and C″ do not bear the same radicals, and
wherein formula (II) at least one of the R₁, R₂, R₃, R₄, R₈, R₉, R₁₀ or R₁₁ radicals is hydrogen and at least one of these radicals is not hydrogen, where the carbon atoms C′ and C″ and/or C″′ and C″″ do not bear the same radicals.

2. The compound of claim 1, wherein the at least one R₁, R₂, R₃ or R₄ radical in formula (I) that is not hydrogen and the at least one R₁, R₂, R₃, R₄, R₈, R₉, R₁₀ or R₁₁ radical in formula (II) that is not hydrogen is a methyl, ethyl, propyl, butyl, hexyl, octyl or perfluoroalkyl radical.

3. The compound of claim 1, wherein R₅ or R₁₂ is a methyl, butyl or ethyl radical.

4. The compound of claim 1, wherein V, W, X and Y are oxygen or D₁ and D₂ are nitrogen.

5. The compound of claim 1, wherein R₆ and R₇ are identical.

6. The compound of formula (II) of claim 1, wherein at least one R₁, R₂, R₃, R₄, R₈, R₉, R₁₀ or R₁₁ radical in formula (II) that is not hydrogen is a methyl, ethyl, propyl, butyl, hexyl, octyl or perfluoroalkyl radical, and R₅ and R₁₂ are independently aliphatic, (cyclo)aliphatic or aromatic radicals that are optionally substituted or have heteroatoms, and in that V, W, X and Y are oxygen and D₁ and D₂ are nitrogen.

7. The compound of formula (II) of claim 1, wherein
R₁ is a methyl radical, and the R₂, R₃, R₄, Ra, R₉, R₁₀ and R₁₁ radicals are hydrogen,
or
R₁ and R₂ are the same or different and are a methyl radical, and the R₃, R₄, R₈, R₉, R₁₀ and R₁₁ radicals are hydrogen,
or
R₁ and R₁₀ are the same or different and are a methyl radical, and the R₂, R₃, R₄, Ra, R₉ and R₁₁ radicals are hydrogen,
or
R₁, R₂ and R₁₀ are the same or different and are a methyl radical, and the R₃, R₄, Ra, R₉ and R₁₁ radicals are hydrogen,
or
R₁, R₂, R₁₀ and R₁₁ are the same or different and are a methyl radical, and the R₃, R₄, R₈ and R₉ radicals are hydrogen,
and
in that R₅ and R₁₂ are the same and are a methyl, butyl or ethyl radical,
and W, X and Y are oxygen and D₁ and D₂ are nitrogen.

8. The compound of claim 1, wherein the compound is selected from the group comprising 2,2-dichloro-4,6-dimethyl-1,3,6,2-dioxazastannocane, 2,2-dibromo-4,6-dimethyl-1,3,6,2-dioxazastannocane, 2,2-dimethoxy-4,6-dimethyl-1,3,6,2-dioxazastannocane, 4,6-dimethyl-1,3,6,2-dioxazastannocane-2,2-diyl dibenzoate, 6-ethyl-4-methyl-1,3,6,2-dioxazastannocane-2,2-diyl dibenzoate, 6-butyl-4-methyl-1,3,6,2-dioxazastannocane-2,2-diyl dibenzoate, 2,4,12-trimethyl-1,7,9,15-tetraoxa-4,12-diaza-8-stannaspiro[7.7]pentadecane, 2,2,4,12-tetramethyl-1,7,9,15-tetraoxa-4,12-diaza-8-stannaspiro[7.7]pentadecane, 2,4,10,12-tetramethyl-1,7,9,15-tetraoxa-4,12-diaza-8-stannaspiro[7.7]pentadecane, 2,2,4,10,12-pentamethyl-1,7,9,15-tetraoxa-4,12-diaza-8-stannaspiro[7.7]pentadecane, 2,2,4,10,10,12-hexamethyl-1,7,9,15-tetraoxa-4,12-diaza-8-stannaspiro[7.7]pentadecane, 2,2,4,6,10,10,12-heptamethyl-1,7,9,15-tetraoxa-4,12-diaza-8-stannaspiro[7.7]pentadecane, 2,2,4,6,6,10,10,12-octamethyl-1,7,9,15-tetraoxa-4,12-diaza-8-stannaspiro[7.7]pentadecane, 2,2,4,6,6,10,10,12,14-nonamethyl-1,7,9,15-tetraoxa-4,12-diaza-8-stannaspiro[7.7]pentadecane, 4,12-diethyl-2-methyl-1,7,9,15-tetraoxa-4,12-diaza-8-stannaspiro[7.7]pentadecane, 4,12-diethyl-2,2-dimethyl-1,7,9,15-tetraoxa-4,12-diaza-8-stannaspiro[7.7]pentadecane, 4,12-diethyl-2,10-dimethyl-1,7,9,15-tetraoxa-4,12-diaza-8-stannaspiro[7.7]pentadecane, 4,12-diethyl-2,2,10-trimethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-diethyl-2,2,6,10,10-pentamethyl-1,7,9,15-tetraoxa-4,12-diaza-8-stannaspiro[7.7]pentadecane, 4,12-diethyl-2,2,6,6,10,10-hexamethyl-1,7,9,15-tetraoxa-4,12-diaza-8-stannaspiro[7.7]pentadecane, 4,12-diethyl-2,2,6,6,10,10,14-heptamethyl-1,7,9,15-tetraoxa-4,12-diaza-8-stannaspiro[7.7]pentadecane, 4,12-dibutyl-2-methyl-1,7,9,15-tetraoxa-4,12-diaza-8-stannaspiro[7.7]pentadecane, 4,12-dibutyl-2,2-dimethyl-1,7,9,15-tetraoxa-4,12-diaza-8-stannaspiro[7.7]pentadecane, 4,12-dibutyl-2,10-dimethyl-1,7,9,15-tetraoxa-4,12-diaza-8-stannaspiro[7.7]pentadecane, 4,12-dibutyl-2,2,10-trimethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dibutyl-2,2,6,10,10-pentamethyl-1,7,9,15-tetraoxa-4,12-diaza-8-stannaspiro[7.7]pentadecane, 4,12-dibutyl-2,2,6,6,10,10-hexamethyl-1,7,9,15-tetraoxa-4,12-diaza-8-stannaspiro[7.7]pentadecane, 4,12-dibutyl-2,2,6,6,10,10,14-heptamethyl-1,7,9,15-tetraoxa-4,12-diaza-8-stannaspiro[7.7]pentadecane, 4,12-dibutyl-2-(trifluoromethyl)-1,7,9,15-tetraoxa-4,12-diaza-8-stannaspiro[7.7]pentadecane, 4,12-dibutyl-2,10-bis(trifluoromethyl)-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof.

9. (canceled)

10. A formulation for production of polyisocyanate polyaddition products, comprising the following components:
a) at least one aliphatic, (cyclo)aliphatic or aromatic polyisocyanate that is optionally substituted and/or has heteroatoms;
b) at least one compound of claim 1 as catalyst;
c) optionally further catalysts other than b);
d) optionally auxiliaries and/or additives,
where the ratio of the weight of tin from component b) and the weight of component a) is preferably not more than 1000 ppm when component a) is an aliphatic or (cyclo)aliphatic polyisocyanate, and is not more than 50 ppm when component a) is an aromatic polyisocyanate.

11. The formulation of claim 10, wherein the formulation contains
5% to 80% by weight of component a);
0.0001% to 2.0% by weight of component b);
optionally 0.01% to 2.0% by weight of component c);
optionally 5% to 50% by weight of component d);
based on the total weight of the formulation.

12. A process for producing polyisocyanate polyaddition products by reaction of a composition:
comprising the following components:
A) at least one aliphatic, (cyclo)aliphatic or aromatic polyisocyanate that is optionally substituted and/or has heteroatoms;
B) at least one NCO-reactive compound;
C) at least one compound of claim 1 as catalyst;
D) optionally further catalysts other than C);
E) optionally auxiliaries and/or additives,
where the ratio of the weight of tin from component C) and the weight of component A) is preferably not more than 1000 ppm when component A) is an aliphatic or (cyclo)aliphatic polyisocyanate, and is not more than 50 ppm when component A) is an aromatic polyisocyanate.

13. The process of claim 12, wherein the composition contains
5% to 80% by weight of component A);
5% to 80% by weight of component B);
0.0001% to 2.0% by weight of component C);
optionally 0.01% to 2.0% by weight of component D);
optionally 5% to 50% by weight of component E);
based on the total weight of the composition, and/or in that the reaction is effected at an isocyanate index of 80 to 150.

14-15. (canceled)

16. The compound of formula (II) of claim 1, wherein the at least one R₁, R₂, R₃, R₄, R₈, R₉, R₁₀ or R₁₁ radical in formula (II) that is not hydrogen is a methyl, ethyl, propyl, butyl, hexyl, or octyl or perfluoroalkyl radical, and R₅ and R₁₂ are the same and are a methyl, ethyl, propyl, butyl, pentyl, hexyl or octyl radical, and V, W, X and Y are oxygen and D₁ and D₂ are nitrogen.

17. The compound of formula (II) of claim 1, wherein the at least one R₁, R₂, R₃, R₄, R₈, R₉, R₁₀ or R₁₁ radical in formula (II) that is not hydrogen is a methyl, ethyl, propyl, butyl, hexyl, octyl or perfluoroalkyl radical, and R₅ and R₁₂ are the same and are a methyl, butyl or ethyl radical, and V, W, X and Y are oxygen and D₁ and D₂ are nitrogen.

18. The compound of claim 1, wherein the compound is selected from the group comprising 2,4,12-trimethyl-1,7,9,15-tetraoxa-4,12-diaza-8-stannaspiro[7.7]pentadecane, 2,2,4,12-tetramethyl-1,7,9,15-tetraoxa-4,12-diaza-8-stannaspiro[7.7]pentadecane, 2,4,10,12-tetramethyl-1,7,9,15-tetraoxa-4,12-diaza-8-stannaspiro[7.7]pentadecane, 2,2,4,10,12-pentamethyl-1,7,9,15-tetraoxa-4,12-diaza-8-stannaspiro[7.7]pentadecane, 2,2,4,10,10,12-hexamethyl-1,7,9,15-tetraoxa-4,12-diaza-8-stannaspiro[7.7]pentadecane, 2,2,4,6,10,10,12-heptamethyl-1,7,9,15-tetraoxa-4,12-diaza-8-stannaspiro[7.7]pentadecane, 2,2,4,6,6,10,10,12-octamethyl-1,7,9,15-tetraoxa-4,12-diaza-8-stannaspiro[7.7]pentadecane, 2,2,4,6,6,10,10,12,14-nonamethyl-1,7,9,15-tetraoxa-4,12-diaza-8-stannaspiro[7.7]pentadecane, 4,12-diethyl-2-methyl-1,7,9,15-tetraoxa-4,12-diaza-8-stannaspiro[7.7]pentadecane, 4,12-diethyl-2,2-dimethyl-1,7,9,15-tetraoxa-4,12-diaza-8-stannaspiro[7.7]pentadecane, 4,12-diethyl-2,10-dimethyl-1,7,9,15-tetraoxa-4,12-diaza-8-stannaspiro[7.7]pentadecane, 4,12-diethyl-2,2,10-trimethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-diethyl-2,2,6,10,10-pentamethyl-1,7,9,15-tetraoxa-4,12-diaza-8-stannaspiro[7.7]pentadecane, 4,12-diethyl-2,2,6,6,10,10-hexamethyl-1,7,9,15-tetraoxa-4,12-diaza-8-stannaspiro[7.7]pentadecane, 4,12-diethyl-2,2,6,6,10,10,14-heptamethyl-1,7,9,15-tetraoxa-4,12-diaza-8-stannaspiro[7.7]pentadecane, 4,12-dibutyl-2-methyl-1,7,9,15-tetraoxa-4,12-diaza-8-stannaspiro[7.7]pentadecane, 4,12-dibutyl-2,2-dimethyl-1,7,9,15-tetraoxa-4,12-diaza-8-stannaspiro[7.7]pentadecane, 4,12-dibutyl-2,10-dimethyl-1,7,9,15-tetraoxa-4,12-diaza-8-stannaspiro[7.7]pentadecane, 4,12-dibutyl-2,2,10-trimethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dibutyl-2,2,6,10,10-pentamethyl-1,7,9,15-tetraoxa-4,12-diaza-8-stannaspiro[7.7]pentadecane, 4,12-dibutyl-2,2,6,6,10,10-hexamethyl-1,7,9,15-tetraoxa-4,12-diaza-8-stannaspiro[7.7]pentadecane, 4,12-dibutyl-2,2,6,6,10,10,14-heptamethyl-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof.

19. The compound of claim 1, wherein the compound is selected from the group comprising 2,2,4,10,10,12-hexamethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane, 4,12-dipropyl-2,2,10,10-tetramethyl-1,7,9,15-tetraoxa-4,12-diaza-8-stannaspiro[7.7]pentadecane, 4,12-dipentyl-2,2,10,10-tetramethyl-1,7,9,15-tetraoxa-4,12-diaza-8-stannaspiro[7.7]pentadecane, 4,12-dihexyl-2,2,10,10-tetramethyl-1,7,9,15-tetraoxa-4,12-diaza-8-stannaspiro[7.7]pentadecane, 4,12-dioctyl-2,2,10,10-tetramethyl-1,7,9,15-tetraoxa-4,12-diaza-8-stannaspiro[7.7]pentadecane or mixtures thereof.

20. The compound of claim 1, wherein the compound is selected from the group comprising 2,2,4,10,10,12-hexamethyl-1,7,9,15-tetraoxa-4,12-diaza-8-stannaspiro[7.7]pentadecane, 4,12-diethyl-2,2,10,10-tetramethyl-1,7,9,15-tetraoxa-4,12-diaza-8-stannaspiro[7.7]pentadecane, 4,12-dibutyl-2,2,10,10-tetramethyl-1,7,9,15-tetraoxa-4,12-diaza-8-stannaspiro[7.7]pentadecane or mixtures thereof.
